(19) United States
(12) Patent Application Publication
(10) Pub. No.: US 2026/0229784 A1
(43) Pub. Date: Aug. 6, 2026

(54) HIGH GAIN METAMATERIAL LOADED SLOT ANTENNA

(71) Applicant: Avery Dennison Retail Information Services LLC, Mentor, OH (US)

(72) Inventor: Kunalen THIRAPPA, Penang (MY)

(21) Appl. No.: 19/148,450

(22) PCT Filed: Jan. 29, 2024
(86) PCT No.: PCT/IB2024/050819

§ 371 Date: Jul. 16, 2025

Related U.S. Application Data
(60) Provisional application No. 63/482,125, filed on Jan. 30, 2023.

(51) Int. Cl. H01Q 13/10; H01Q 1/22; H01Q 1/38; H01Q 15/00

(52) U.S. Cl. CPC H01Q 13/10; H01Q 1/22; H01Q 1/38; H01Q 15/0086

(57) ABSTRACT

The present subject matter provides an RFID device that is configured to provide improved gain and directivity of an antenna. The RFID device includes an antenna, a metamaterial (MTM) array, and a substrate. The substrate includes a first surface and a second surface, and the antenna includes a bottom surface and a top surface. The bottom surface of the antenna and the MTM array are formed on the first surface of the substrate. The antenna and the MTM array are separated by a gap. The antenna is formed by a first electrically conductive material defining an area enclosed by a first perimeter. The antenna includes nested slots. The MTM array is formed by a second electrically conductive material defining an area enclosed by a second perimeter.

### CROSS-REFERENCE TO RELATED APPLICATION

This application claims the benefit of U.S. Provisional Patent Application No. 63/482,125 filed Jan. 30, 2024, which is incorporated by reference herein in its entirety.

### FIELD

Antenna designs, particularly RFID antenna designs and RFID devices that include an antenna and metamaterial (MTM) array that enhances gain and directivity of the antenna.

### BACKGROUND

Radio-frequency identification (RFID) technology is experiencing rapid growth in a wide range of applications, including object tracking, supply chain processes, highway toll collection systems, automated parking, and fuel-filling stations. Typically, an RFID system includes an RFID tag containing an integrated circuit (IC) chip, an antenna, and an RFID reader. The fundamental operation involves data transfer/communication between the RFID reader and the RFID tag. In the context of a highway toll collection system, the RFID tag is usually installed on a vehicle's windshield, while the RFID reader is mounted on a toll gate. The effectiveness of communication depends on factors such as the type of tag (i.e., passive or active), RFID tag read range, RFID reader mounting angle and height, RFID frequency and interference in the surrounding environment or from other RFID tags and readers.

At toll plazas, existing RFID systems encounter various challenges, including poor RFID tag detection, interference caused by the installation of metallic films on vehicle windshields, and increased wait times for vehicles in queues. For example, longer wait times at highway toll collection points are driven by the requirement to identify and categorize vehicles, even as they are moving. The toll collection process demands real-time recognition and classification of vehicles, so if RFID tags are not detected properly it can contribute to delays in the queue. The issue of poor RFID tag detection is typically attributed to the RFID reader antenna angle setup, specifically when the RFID reader antenna is set up at an angle between 30 to 90 degrees. For example, if the RFID reader is installed on the side of the toll booth facing the incoming vehicles, the angle may be set up with respect to a reference point. In this context, a 90 degree angle setup for RFID reader means that the RFID reader antenna is positioned 90 degrees away from the reference point. Detecting conventional RFID tags can be challenging when the RFID reader antenna is positioned at a specific angle, especially within the range of 30 to 90 degrees. This specific reader antenna configuration introduces complexities in achieving efficient tag detection for conventional tags, as it might not align effectively with the necessary preferred orientation for reliable RFID communication with the tags. Conventional RFID tags do not achieve maximum performance at defined angles (i.e., 30 to 90 degrees) and therefore do not perform as well as might otherwise be possible. In addition, windshields to which a metalized film has been applied pose significant performance issues for RFID tags that are applied to such windshields. Metalized film comprises very small metallic particles, invisible to the eye, that work to reflect light (such as ultraviolet) and heat to some degree. However, it can interfere with radio frequency signals.

There is a need to overcome the abovementioned limitations and drawbacks related to conventional wireless communication devices, i.e., RFID devices. Furthermore, there is a need for a simplified RFID device structure, thereby obtaining high gain and directivity for the antenna of the RFID device.

### SUMMARY

The following presents a general summary in order to provide a basic understanding of some aspects of the disclosed innovation. This summary is not an extensive overview, and it is not intended to identify or limit key/critical elements or to delineate the scope thereof. Its sole purpose is to present some concepts in a general form as a prelude to the more detailed description that is presented later.

An RFID device, with increased or improved gain and directivity of an antenna is described herein. In some embodiments, the RFID device includes an antenna, a metamaterial (MTM) array, and a substrate. The substrate is a flexible material having a first surface and a second surface. The antenna further includes a bottom surface and a top surface. Furthermore, the bottom surface of the antenna and the MTM array are formed on the first surface of the substrate. The antenna and the MTM array are separated by a gap. The antenna is formed by a first electrically conductive material defining an area enclosed by a first perimeter. Further, the antenna may include nested slots. In some embodiments, a chip is disposed on the top surface of the antenna. The chip is electrically coupled to the antenna.

In some embodiments, the MTM array is formed by a second electrically conductive material enclosed by a second perimeter. An elongated edge of the second perimeter of the MTM array is disposed parallel to an elongated edge of the first perimeter of the antenna. The antenna and the MTM array are co-planar to each other, and the antenna is inductively coupled to the MTM array. Furthermore, the MTM array comprises an M×N array configuration. The M×N MTM array configuration comprises ‘M’ number of MTM rows and ‘N’ number of MTM columns.

Each of the plurality of the MTM cells is spaced by a predetermined distance from corresponding one or more adjacent MTM cells. Furthermore, a response of the antenna is a function of the impedance characteristics of the antenna, the MTM array and a negative permeability of the MTM.

In some embodiments, the RFID device includes one or more fragile areas. Each of the one or more fragile areas is defined at a predetermined distance from the chip. The one or more fragile areas are configured to break when an attempt is made to remove the affixed RFID device. The one or more fragile areas extend across at least a portion of the antenna and the MTM array, such that when the RFID device is broken along the one or more fragile areas of the RFID device is rendered unable to communicate with a RFID reader. In some embodiments, the substrate has an adhesive coating applied to the second surface thereof, to enable the RFID device to be affixed to a glass material associated with a vehicle. In some embodiments, the RFID device is configured to be read by the RFID reader when positioned at a specific angle, including ranges from 30 to 90 degrees away from a reference point, facilitating more effective information retrieval from the affixed RFID device.

### BRIEF DESCRIPTION OF THE DRAWINGS

The summary above, as well as the following detailed description of illustrative embodiments, is better understood when read in conjunction with the drawings. For the purpose of illustrating the present subject matter, exemplary constructions of the subject matter are shown in the drawings. However, the present subject matter is not limited to specific methods and instrumentalities disclosed herein. Moreover, those skilled in the art will understand that the drawings are not to scale. Wherever possible, like elements have been indicated by identical numbers.

FIG. 1 illustrates a schematic illustration of an RFID device, in accordance with an embodiment;

FIGS. 2A and 2B illustrate a schematic illustration of an MTM array, in accordance with an embodiment;

FIGS. 3A and 3B illustrate a plan view of an RFID device, in accordance with an embodiment;

FIGS. 4A and 4B illustrate example simulation results of the RFID device, in accordance with an embodiment;

FIG. 5 illustrates a graph showing an example read range result of the RFID device, in accordance with an embodiment; and

FIG. 6 illustrates a graph showing an example gain result of the RFID device, in accordance with an embodiment.

In the accompanying drawings, an underlined number is employed to represent an item over that the underlined number is positioned or an item to that the underlined number is adjacent. A non-underlined number relates to an item identified by a line linking the non-underlined number to the item. When a number is non-underlined and accompanied by an associated arrow, the non-underlined number is used to identify a general item at that the arrow is pointing.

### DETAILED DESCRIPTION

Before the present subject matter is described in further detail, it is to be understood that the subject matter is not limited to the particular embodiments described, as such may, of course, vary. It is also to be understood that the terminology used herein is for the purpose of describing particular embodiments only and is not intended to be limiting because the scope of the present subject matter will be limited only by the appended claims.

Unless defined otherwise, all technical and scientific terms used herein have the same meaning as commonly understood by one of ordinary skill in the art to which this disclosure applies. It must be noted that as used herein and in the appended claims, the singular forms “a”, “an”, and “the” include plural referents unless the context clearly dictates otherwise.

The following detailed description illustrates various embodiments of the present subject matter and ways in which they may be implemented. Although a limited number of the exemplary methods and materials are described herein for clarity, those of ordinary skill in the art to which this disclosure applies will understand other methods and materials for carrying out or practicing the present subject matter are also possible.

### I. Definitions

“RFID” as used herein refers to radio frequency identification devices.

“RFID Device” as used herein in refers to a device that includes an antenna and a MTM array.

“RFID reader” as used herein in refers to a device that includes one or more antennas that emit radio waves and receive signals back from the RFID device.

“RFID tag” as used herein refers to a label that includes the RFID device that may be attached to a vehicle windshield to identify the vehicle at a toll plaza, parking lot or garage, fuel filling station, or the like.

“Substrate” as used herein refers to a dielectric material. The dielectric material is a non-metallic substance having a high specific resistance.

“Negative permeability” as used herein refers to a negative magnetic permeability when a material, in response to an imposed magnetic field, forms a magnetic dipole in the opposite direction to the imposed magnetic field.

“Gain” as used herein, in a transmitting antenna, describes how well the antenna converts input power into radio waves headed in a specified direction. In a receiving antenna, the gain describes how well the antenna converts radio waves arriving from a specified direction into electrical power.

“Read range” as used herein refers to a maximum distance within which an RFID Device can detect radio waves from an RFID reader. Whenever the RFID device is within this range, it becomes active and allows the RFID reader to capture information.

“Directivity” as used herein refers to an ability of an antenna to focus the radiation to a particular direction.

“Metamaterial” (MTM) is any material engineered to have a property that is not found in naturally occurring materials. They are made from assemblies of multiple elements fashioned from composite materials such as metals and plastics. These materials are usually arranged in repeating patterns, at scales that are smaller than the wavelengths of the phenomena they influence. MTMs derive their properties not from the properties of the base materials, but from their newly designed structures. Their precise shape, geometry, size, orientation and arrangement gives them their smart properties capable of manipulating electromagnetic waves: by blocking, absorbing, enhancing, or bending waves, to achieve benefits that go beyond what is possible with conventional materials.

“Perimeter” as used herein refers to a boundary of a conductive material.

“Antenna” as used herein refers to a conductor configured to transmit or receive electromagnetic radiation.

In context of an RFID reader, the term “reference point” refers to a starting or zero position used as the basis for measuring the angle of the RFID reader relative to incoming vehicles and direction of the road.

These and other features, aspects, embodiments, and advantages of the present subject matter will be better understood with reference to the below stated description and appended claims. These definitions are provided to introduce a selection of concepts in a simplified form. These definitions are not intended to identify key or essential features, of the claimed or disclosed subject matter, nor is it intended to be used to limit the scope of the claimed subject matter.

### II. Improved Gain and Directivity of an Antenna of an RFID Device

The RFID device disclosed herein is described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. may be made and may be desired for a specific application.

In the present disclosure, any identification of specific shapes, materials, techniques, arrangements, etc., is either related to a specific example presented or is a general description. Specific details or examples are not intended to be, and should not be, construed as mandatory or limiting unless specifically designated as such.

In some embodiments, the present subject matter relates to an RFID device that includes an antenna and a MTM array. Both the antenna and the MTM array are designed, constructed, and configured in such a way that the RFID device utilizes the antenna and the MTM array together to enhance the gain and the directivity of the antenna when exposed to incoming radio waves from an RFID reader.

Throughout the present description, the RFID device refers to a wireless identification device installed on a vehicle, particularly on a windshield, to enable vehicle identification when the RFID device is interrogated by an RFID reader. In response to the interrogation, the RFID device sends vehicle identification information (e.g., one or more identifiers) that allows service providers to identify and debit an amount from an e-wallet associated with the vehicle. As described herein, nested slots refers to an antenna having plurality of slots.

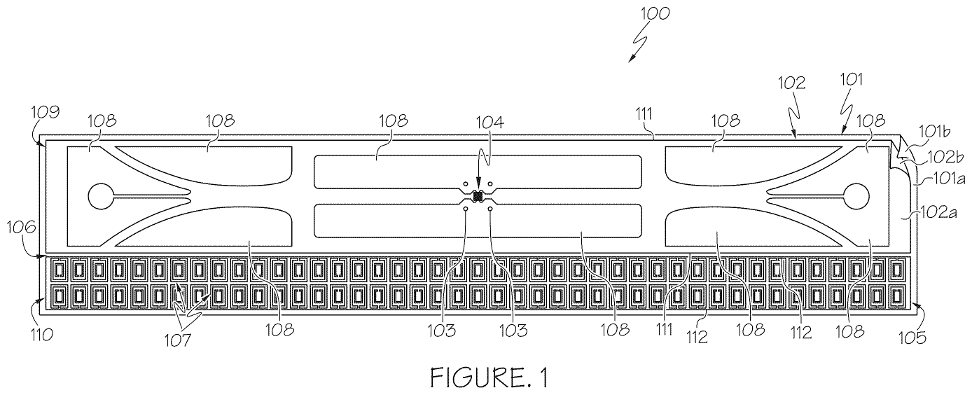

FIG. 1 illustrates a schematic illustration of an RFID device 100, in accordance an embodiment. The RFID device 100 for an RFID tag that has both high gain and a wide read range is described herein. The RFID tag includes the RFID device 100, adhesive coating (not shown in FIG. 1) and a peeling liner (not shown in FIG. 1). The RFID tag may be affixed to a vehicle (not shown in FIG. 1), particularly on a windshield (not shown in FIG. 1), upon peeling the peeling liner.

The RFID device 100 includes a substrate 101, an antenna 102, and an MTM array 105. The substrate 101 is a flexible material having a first surface 101a and a second surface 101b. The antenna 102 and the MTM array 105 are formed on the first surface 101a of the substrate 101. The antenna 102 is formed by a first conductive material defining an area enclosed by a first perimeter 109 of a rectangular shape. The first conductive material may include metal (e.g., aluminium or copper) or any other electrically-conductive materials known in the art (e.g., conductive ink). The antenna 102 with the multiple slots or nested slots 108 may be designed to have specific shapes and dimensions to achieve the desired electrical performance. The specific shapes and dimensions of the slots 108 may be created by performing a cut operation on the first conductive material at various locations to form the antenna 102 such as the one shown in FIG. 1. Furthermore, cutting may be accomplished via mechanical die cutting, etching, laser cutting or any other suitable means to cut and then remove the unwanted material such as nested slots 108. Alternatively, if the antenna 102 is formed by the printing of a conductive ink, then the slots 108 may be formed by the pattern of printed ink, in which case cutting may not be necessary. The nested slots 108 refer to the opening or aperture that represents a non-conductive portion of the antenna 102. For example, when the antenna 102 with nested slots 108 is placed on a non-conductive or dielectric material, such as the substrate 101, the nested slots 108 behave as non-conductive portions.

The MTM array 105 is formed by a second electrically conductive material defining an area enclosed by a second perimeter 110 of a rectangular shape. The second conductive material may the same or different than the first conductive material used for the antenna 102. The MTM array 105 of FIG. 1 is formed into an M×N array 105 configuration. The M×N MTM array 105 comprises a plurality of MTM cells 107. The plurality of MTM cells 107 are designed with particular dimensions and geometry configuration, taking careful consideration of their impedance characteristics to ensure compatibility with the antenna 102. The compatibility of the MTM array 105 and the antenna 102 is important because it ensures that the different components (i.e., antenna 105 and MTM array 105) can work together to achieve a desired outcome (e.g., maximizing efficiency, etc.), and avoid potential issues that might arise from mismatched or incompatible components. In an M×N array configuration, ‘M’ indicates a number of rows and ‘N’ indicates a number of columns. The M×N MTM array 105 configuration comprises a plurality of MTM cells 107. For example, the plurality of MTM cells 107 shown in FIG. 1 are arranged in two rows and forty-three columns, i.e., a 2×43 MTM array configuration. According to the particular dimensions and geometry, the plurality of MTM cells 107 are formed on the second electrically conductive material defining the area enclosed by the second perimeter 110 by, for example, a cutting operation.

In the cutting operation, unwanted parts of the MTM array 105 configuration are selectively removed to achieve the desired geometry and dimensions. Furthermore, the cutting may be accomplished via mechanical die cutting, etching, laser cutting or any other suitable means to cut and then remove the unwanted material. The removal of unwanted material creates openings or apertures that represent a non-conductive portion of the MTM array 105. For example, the non-conductive portion may be air, an insulating material, or a dielectric material such as the substrate 101. The specific geometry of the MTM cells 107 includes a shape of the plurality of MTM cells 107. The shape of the plurality of MTM cells 107 may be, for example, a square, rectangle, circle, triangle, or combinations thereof. The specific dimensions of the plurality of MTM cells 107 may include, but are not limited to, a width and a distance. For example, the width of the plurality of MTM cells 107 may include a width of an internal conductor, a width of an external conductor, and the dimensions of the plurality of MTM cells 107 may include a distance between the internal conductor and the external conductor, a distance between each of the plurality of MTM cells 107 from its corresponding one or more adjacent MTM cells 107. Alternatively, if the MTM cells 107 are formed by the printing of a conductive ink, then any openings or apertures may be formed by the pattern of printed ink, in which case cutting may not be necessary. The antenna 102 includes a top surface 102a and a bottom surface 102b. The top surface 102a of the antenna 102 is opposite the bottom surface 102b. The bottom surface 102b of the antenna 102 and the MTM array 105 are positioned on the first surface 101a of the substrate 101 and the antenna 102 and the MTM array 105 are separated by a gap 106. An elongated edge 112 of the second perimeter 110 of the MTM array 105 is positioned parallel to an elongated edge 111 of the first perimeter 109 of the antenna 102. The MTM array 105 and the antenna 102 are co-planar to each other.

The substrate 101 is a dielectric material. The substrate 101 may be any dielectric material known in the art and may be selected for a particular antenna and/or intended application. The substrate may be, but is not limited to, a paper substrate or a Polyethylene terephthalate (PET) substrate. The top surface 102a of the antenna 102 includes one or more feeding point marks 103 and a chip 104. For example, the one or more feeding point marks 103 are used to define a chip landing area. The chip 104 is electrically coupled to the antenna 102. For example, the electrical coupling can be achieved by directly attaching the chip 104 to the antenna 102, or the chip 104 can be attached to the antenna 102 using a strap or using any electrical coupling technique known in the art. The antenna 102 is inductively coupled to the MTM array 105. For example, in inductive coupling, the antenna 102 and the MTM array 105 are coupled via a magnetic field. The antenna 102 is configured to receive incoming electromagnetic signals transmitted from an RFID reader (not shown in FIG. 1). RF power is induced in the antenna 102 by the incoming electromagnetic wave transmitted from the RFID reader. The antenna 102 is further configured to induce the RF power to the MTM array 105 by means of inductive coupling. In another embodiment, the antenna 102 is configured to induce the RF power to the MTM array 105 by means of capacitive coupling.

In an exemplary scenario, the RFID device 100 may be installed on a vehicle windshield. The RFID device 100 includes the substrate 101, the antenna 102, and the MTM array 105. The substrate 101 includes the first surface 101a and the second surface 101b. The antenna 102 and the MTM array 105 are formed on the first surface 101a of the substrate 101. The second surface 101b of the substrate 101 is opposite the first surface 101a. The second surface 101b of the substrate 101 further includes an adhesive coating and the peeling liner. To install the RFID device 100 on the windshield of the vehicle, the peeling liner is removed and the RFID device 100 is affixed to the windshield using the adhesive coating. The adhesive coating enables the substrate 101 bonding to the windshield. The RFID reader can be installed in a toll plaza, parking area, fuel filling station, or the like. The RFID device 100 on the vehicle can communicate with the RFID reader to provide vehicle identification information (e.g., one or more identifiers) that allows service providers to identify and debit an amount from an e-wallet associated with the vehicle. The RFID device 100 is configured to be read by the RFID reader when positioned at a specific angle, including a range from 30 to 90 degrees, facilitating reliable information retrieval from the affixed RFID device 100. For instance, the RFID reader with a 60 degree angle implies that the RFID reader is positioned 60 degrees away from a reference point.

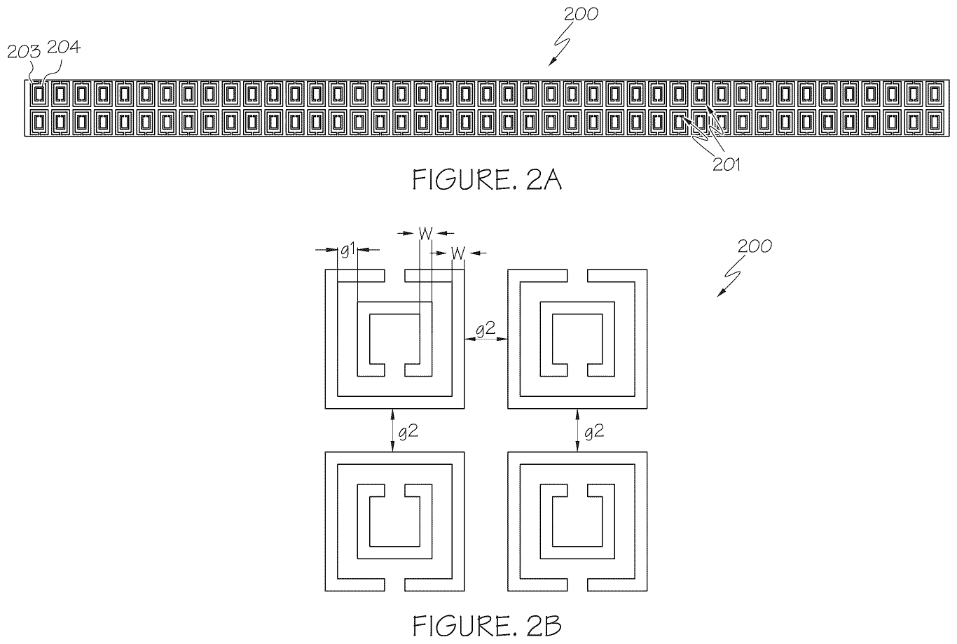

FIGS. 2A and 2B illustrate a schematic illustration of a metamaterial (MTM) array 200, in accordance with an embodiment. The MTM array 200 according to the current embodiment includes a plurality of MTM cells 201 disposed on the substrate 101 (as shown in FIG. 1). Each of the plurality of MTM cells 201 includes an internal conductor 204 and an external conductor 203. The external conductor 203 and the internal conductor 204 formed on the first surface 101a (as shown in FIG. 1) of the substrate 101. The internal conductor 204 is positioned in an opposing direction to the external conductor 203 and located within the external conductor 203. Each of the external conductor 203 and the internal conductor 204 has a split square shape, and is disposed to have a predetermined distance g1 between them. Each of the plurality of the MTM cells 201 is spaced by a predetermined distance g2 from a corresponding one or more adjacent MTM cells 201. In an example MTM array 200 configuration, the predetermined width W of the internal conductor 204 is 0.2 mm, the predetermined width W of the external conductor 203 is 0.2 mm, the distance g1 between the internal conductor 204 and the external conductor 203 is 0.3 mm, and the distance g2 between each MTM cell 201 and corresponding one or more adjacent MTM cells 201 is 0.4 mm. Each of the plurality of MTM cells 201 has split square shape conductors such as the internal conductor 204 and the external conductor 203.

The antenna 102 (as shown in FIG. 1) is configured to receive electromagnetic waves from an RFID reader (not in Figures). Referring back to FIG. 1, the antenna 102 is excited in response to the RF power induced by the incoming electromagnetic wave. Further, the antenna 102 is configured to induce RF power in to the MTM array 105 by means of inductive coupling. The MTM array 105 responds to the induced RF power, and as a result of the excitation in both the antenna 102 and the MTM array 105, currents are distributed in the antenna 102 and the MTM array 105, respectively. This distribution of currents contributes to an overall high current distribution in the RFID device 100. Consequently, the RFID device 100 exhibits high radiation efficiency due to high current distribution. This high current distribution can be attained in the RFID device 100 by achieving impedance matching between the RFID reader and the RFID device 100, including the antenna 102, the chip 104, and the MTM array 105. The impedance matching achieved in the RFID device 100 is based on one or more factors including, but not limited to, the antenna design or impedance network of the antenna 102, the MTM cells 107 geometry and dimensions, impedance characteristics of the antenna 102 and the MTM array 105, and a negative permeability of the MTM. The impedance traits of both antenna 102 and the MTM array 105 may include components related to resistance, capacitance, and inductance. The plurality of MTM cells 107 include a specific geometry such as a split square shape ring, which behaves as an LC (L-inductor and C-capacitor) resonant circuit when excited by RF power, thus providing negative permeability at its resonance frequency. For example, the resonance frequency can be any frequency that falls within the range of the operating frequency of the RFID device, such as Federal Communications Commission (FCC) Ultra High Frequency (UHF) RFID bands, e.g., ranges between 865 MHz to 868 MHz and 902 MHz to 928 MHz. The frequency values 865 MHz to 868 MHz and 902 MHz to 928 MHz are only an example and should not be considered as a limitation, as different frequency bands are authorized for use in different regions or countries. Those skilled in the art will appreciate that the use of the MTM array 105 in antenna 102 configuration improves the overall RFID device 100 parameters such as radiation efficiency, gain, and directivity. The MTM array 105 with negative permeability enhances the antenna 102 properties such as directivity, gain and radiation efficiency. Further, the disclosed antenna 102 with MTM array 105 design may be capable of complex impedance matching even when the RFID device 100 is attached to a high permittivity material, such as tempered glass commonly found in vehicle windshields.

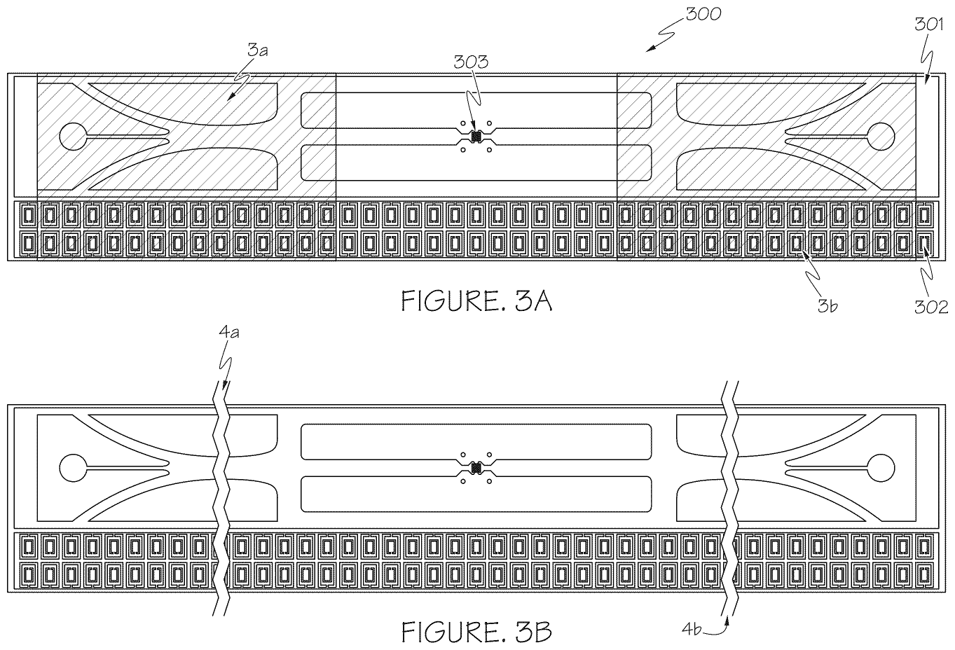

FIGS. 3A and 3B illustrate a plan view of an RFID device 300 in accordance with an embodiment. Referring to FIG. 3A, the RFID device 300 includes one or more fragile areas 3a and 3b. For example, to affix the RFID device 300 on a vehicle windshield, a user removes the peeling liner (not shown in FIGS. 3A and 3B) of the RFID device 300. Upon removing the peeling liner, the adhesive coating layer (not shown in FIGS. 3A and 3B) of the RFID device 300 enables the substrate 101 (as shown in FIG. 1) to bond to the windshield. The one or more fragile areas 3a and 3b may include a fragile conductor material, a special adhesive formulation, or the like. Also referring to FIG. 1, the special adhesive formulation may be coated over the second surface 101b of the substrate 101. Each of the one or more fragile areas 3a and 3b are defined at a predetermined distance from a chip 303, and are configured to break when attempting to remove the affixed RFID device 300. The one or more fragile areas 3a and 3b extend across at least a portion of an antenna 301 and an MTM array 302, such that when the RFID device 300 is broken along the one or more fragile areas 3a and 3b, the RFID device 300 is rendered unable to communicate with the RFID reader. The broken or tampered areas 4a and 4b of RFID device 300 are shown in FIG. 3B.

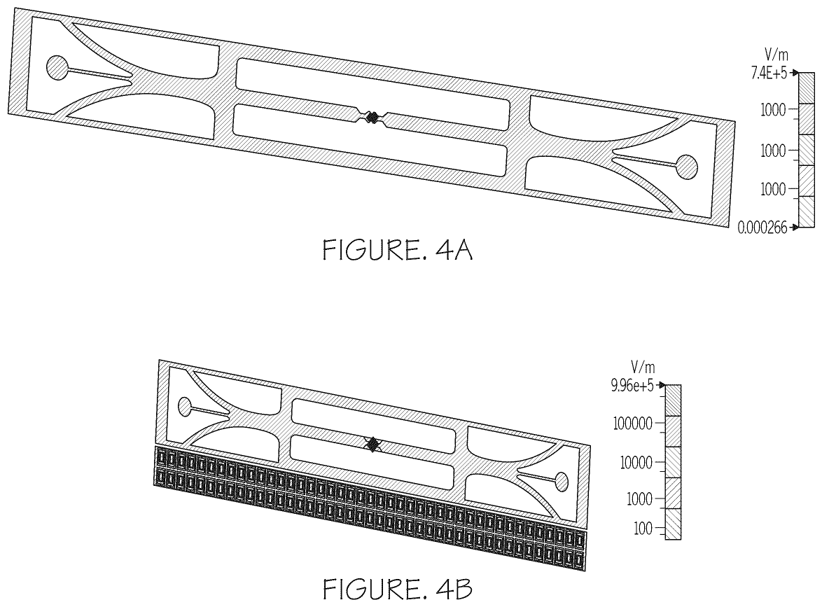

FIGS. 4A and 4B illustrate example simulation results of the RFID device 100 shown in FIG. 1, in accordance with an embodiment. FIG. 4A illustrates the electric field strength of the antenna 102 without the MTM array 105. For example, the electric strength of the antenna 102 without the MTM array 105 is around 7 V/m (volt per meter). FIG. 4B illustrates electric field strength of the antenna 102 with the MTM array 105. For example, the electric strength of the antenna 102 with the MTM array 105 shows around 9 V/m. The electric strength of the RFID device 100 is increased by approximately 2 V/m using the MTM array 105, compared to using only the antenna 102. Thus, using the MTM array 105 with the antenna 102 enhances the gain and the directivity of the antenna 102.

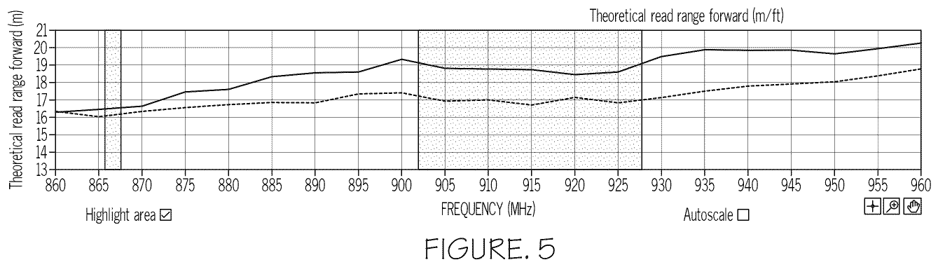

FIG. 5 illustrates a graph showing an example read range result of the RFID device 100 shown in FIG. 1, in accordance with an embodiment. The electric field strength distribution on the antenna 102 and the RFID device 100 is shown in FIGS. 4A and 4B. The read range of the RFID device 100 corresponding to the electric field strength distribution is shown in FIG. 5. The read range is improved by 2 meters when operating in the FCC UHF bands. The dotted line indicates the read range of the antenna 102 without the MTM array 105. The solid line indicates the read range of the antenna 102 with the MTM array 105. The antenna 102 with MTM array 105 has its read range enhanced by 2 meters as compared to the read range of the antenna 102 without the MTM array 105.

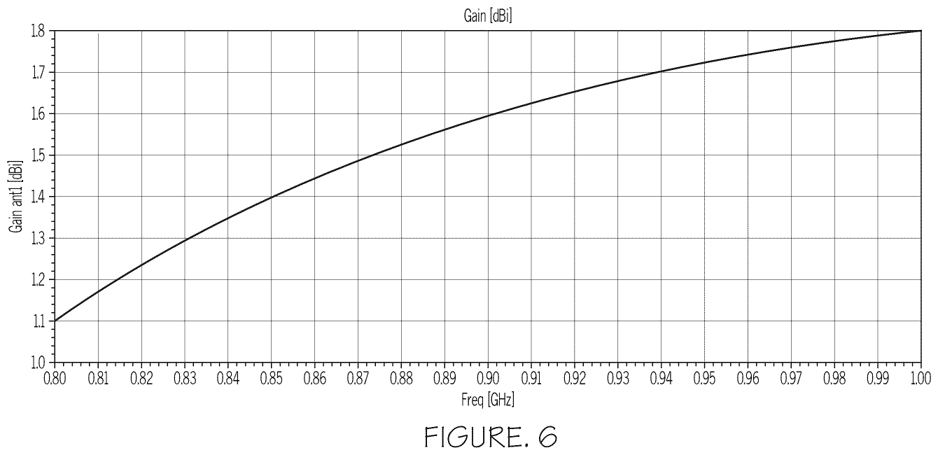

FIG. 6 illustrates a graph showing an example gain result of the RFID device 100 shown in FIG. 1 in accordance with an embodiment. FIG. 6 illustrates a gain of the RFID device 100 that includes the antenna 102 and the MTM array 105.

It should be apparent, however, to those of ordinary skill in the art to which this subject matter pertains that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. An RFID device comprising:
an antenna comprising a bottom surface and a top surface;
a metamaterial (MTM) array; and
a substrate of flexible material having a first surface and a second surface,
wherein the bottom surface of the antenna and the MTM array are formed on the first surface of the substrate, and
wherein the antenna and the MTM array are separated by a gap.

2. The device of claim 1, wherein the antenna is formed by a first electrically conductive material defining an area enclosed by a first perimeter.

3. The device of claim 1, wherein the antenna comprises nested slots.

4. The device of claim 1, wherein the MTM array is formed by a second electrically conductive material defining an area enclosed by a second perimeter.

5. The device of claim 1, wherein an elongated edge of the second perimeter of the MTM array is disposed parallel to an elongated edge of the first perimeter of the antenna.

6. The device of claim 5, wherein the antenna and the MTM array are co-planar to each other.

7. The device of claim 1, wherein a chip is disposed on the top surface of the antenna.

8. The device of claim 7, wherein the chip is electrically coupled to the antenna.

9. The device of claim 1, wherein the antenna is inductively coupled to the MTM array.

10. The device of claim 1, wherein the MTM array comprises an M×N array configuration.

11. The device of claim 10, wherein the M×N MTM array configuration comprises ‘M’ number of MTM rows and ‘N’ number of MTM columns.

12. The device of claim 11, wherein the M×N MTM array configuration comprises a plurality of MTM cells arranged in two rows and forty-three columns.

13. The device of claim 12, wherein each of the plurality of the MTM cells spaced by a predetermined distance from corresponding one or more adjacent MTM cells.

14. The device of claim 11, wherein a shape of the plurality of MTM cells is selected from a group consisting of a square, rectangle, circle, and triangle.

15. The device of claim 1, wherein a response of the RFID device is a function of an impedance characteristic of the antenna and the MTM array and a negative permeability of the MTM.

16. The device of claim 1, wherein the substrate has an adhesive coating applied to the second surface thereof.

17. The device of claim 1, wherein the RFID device further comprises one or more fragile areas.

18. The device of claim 17, wherein each of the one or more fragile areas are defined at a predetermined distance from the chip, wherein the one or more fragile areas are configured to break when attempting to remove the affixed RFID device.

19. The device of claim 18, wherein the one or more fragile areas extends across at least a portion of the antenna and the MTM array, such that when the RFID device is broken along the one or more fragile areas of the RFID device is rendered unable to communicate with an RFID reader.

20. The device of claim 1, wherein the RFID device is configured to be read by the RFID reader when positioned at a specific degree including ranges from 30 to 90 degrees away from a reference point, facilitating reliable functionality for information retrieval from the affixed RFID device.
